(19) United States
(12) Patent Application Publication
(10) Pub. No.: US 2024/0242124 A1
(43) Pub. Date: Jul. 18, 2024

(54) LEARNING DEVICE, LEARNING SYSTEM, METHOD, AND PROGRAM

(71) Applicant: NEC Corporation, Minato-ku, Tokyo (JP)

(72) Inventors: Ryota HIGA, Tokyo (JP); Shinji NAKADAI, Tokyo (JP)

(73) Assignee: NEC Corporation, Minato-ku, Tokyo (JP)

(21) Appl. No.: 18/563,046

(22) PCT Filed: May 28, 2021
(86) PCT No.: PCT/JP2021/020454

§ 371 Date: Nov. 21, 2023

(51) Int. Cl. G06N 20/00

(52) U.S. Cl. CPC G06N 20/00

(57) ABSTRACT

The input means 81 accepts input of a reward function that defines cumulative reward by a reward term based on a high-level indicator representing a production indicator. The learning means 82 learns a value function for deriving optimal policy for an agent using training data and the reward function. The output means 83 outputs the learned value function.

### TECHNICAL FIELD

This invention relates to a learning device, a learning system, a learning method, and a learning program for learning a model for controlling an action of an agent.

### BACKGROUND ART

Proper planning in a production site is an important business issue in companies. For example, various plans are needed for more appropriate production, such as plans for stock control and production quantity control, route plans for robots to be used, and so on. Therefore, various methods have been proposed to perform appropriate planning.

For example, Non-patent Literature 1 describes a method for finding routes for multiple agents in a pickup and delivery task. In the method described in Non-patent Literature 1, planning is performed to optimize task assignment costs and route costs for AGVs (Automatic Guided Vehicles).

### CITATION LIST

### Non Patent Literature

NPL 1: Ma, H., Kumar, T. K. S., Li, J., & Koenig, S., “Lifelong multi-Agent path finding for online pickup and delivery tasks”. Proceedings of the International Joint Conference on Autonomous Agents and Multiagent Systems, AAMAS, 2, pp. 837-845, May 2017.

### SUMMARY OF INVENTION

### Technical Problem

By using the algorithm described in Non-patent Literature 1, it is possible to perform shortest route planning that prevents multiple AGVs from colliding. Here, minimization of work time and minimization of transportation time, such as shortest route planning, can be considered as one of the important management indicators (KPI: Key Performance Indicators), but in general, the management indicators to be considered are not limited to these optimizations.

The shortest route planning of AGV is an indicator from physical aspect (hereinafter referred to as “physical indicator”) that is taken into consideration when transporting parts for production. On the other hand, in production planning, there are not only physical indicator as described above, but also indicator from logical aspect (hereinafter referred to as “logical indicator”) that are taken into consideration when managing stock quantity and production quantity.

From another perspective, such as optimized AGV routes, indicators that are not directly related to costs like sales and profits can be referred to as lower-level indicators. While, like stock quantity and production quantity, so-called production indicators that are directly related to costs can be referred to as high-level indicators.

In this perspective, the method described in Non-patent Literature 1 is a method to optimize only so-called lower-level indicators, so the optimized indicators do not necessarily satisfy the high-level indicators. Therefore, it is desirable to be able to construct a model that derives optimal policy for an agent so that the production indicator (high-level indicator) considered from the logical point of view can be increased.

Therefore, it is an exemplary object of the present invention to provide a learning device, a learning system, a learning method, and a learning program that can learn a model that derives optimal policy for an agent while increasing a high-level indicator representing a production indicator.

### Solution to Problem

A learning device according to the present invention includes an input means which accepts input of a reward function that defines cumulative reward by a reward term based on a high-level indicator representing a production indicator, a learning means which learns a value function for deriving optimal policy for an agent using training data and the reward function, and an output means which outputs the learned value function.

A learning system according to the present invention includes a simulator which outputs data including a high-level indicator, location information of an agent, an action of the agent, and reward information according to the action, from map information which is information indicating operating area of the agent, related agent information which is information of other related agents, the high-level indicator which represents a production indicator, and a route plan of the agent, and a learning device that uses data output from the simulator as training data for learning, wherein the learning system includes an input means which accepts input of a reward function that defines cumulative reward by a reward term based on the high-level indicator, a learning means which learns a value function for deriving optimal policy for the agent using the training data and the reward function, and an output means which outputs the learned value function.

A learning method according to the present invention includes: accepting input of a reward function that defines cumulative reward by a reward term based on a high-level indicator representing a production indicator by a computer; learning a value function for deriving optimal policy for an agent using training data and the reward function by the computer; and outputting the learned value function by the computer.

A learning program according to the present invention for causing a computer to execute: input process for accepting input of a reward function that defines cumulative reward by a reward term based on a high-level indicator representing a production indicator; learning process for learning a value function for deriving optimal policy for an agent using training data and the reward function; and output process for outputting the learned value function.

### Advantageous Effects of Invention

According to the present invention, it is possible to learn a model that derives optimal policy for an agent while increasing high-level indicator that represents production indicator.

### BRIEF DESCRIPTION OF DRAWINGS

FIG. 1 It depicts a block diagram illustrating a configuration example of one exemplary embodiment of a learning system according to the present invention.

FIG. 2 It depicts a flowchart illustrating an operation example of the learning system.

FIG. 3 It depicts an explanatory diagram showing an example of a factory line.

FIG. 4 It depicts a block diagram illustrating the outline of a learning device according to the present invention.

FIG. 5 It depicts a block diagram illustrating the outline of a learning system according to the present invention.

FIG. 6 It depicts a schematic block diagram illustrating a configuration of a computer according to at least one of exemplary embodiments.

### DESCRIPTION OF EMBODIMENTS

At the outset, the issues assumed by this invention will be explained using the production process in a factory line as an example. For example, optimizing the transportation of parts on a factory line is an important business issue directly related to inventory control and production quantity control. The route planning of a robot (hereinafter referred to as an agent) on a factory line is, for example, performed by solving a shortest route planning problem, which is usually performed independently of inventory control and production quantity.

However, even if parts transportation is optimized, if the production performance of the destination is not able to keep up, the transported parts will need to be temporarily stored as inventory, which may result in a deterioration of the company's overall profitability. To address these issues, the inventor has found a method that can learn a model (value function) that can determine policy of robot (mobile agent) while taking into account the high-level indicators of the entire factory, such as production quantity and stock quantity. This makes it possible to realize agent's policy (route planning) that can maximize the production quantity while decreasing the stock quantity, i.e., determining the agent's action that optimizes both physical and logical indicators.

The following is a description of the exemplary embodiment of the invention with reference to the drawings.

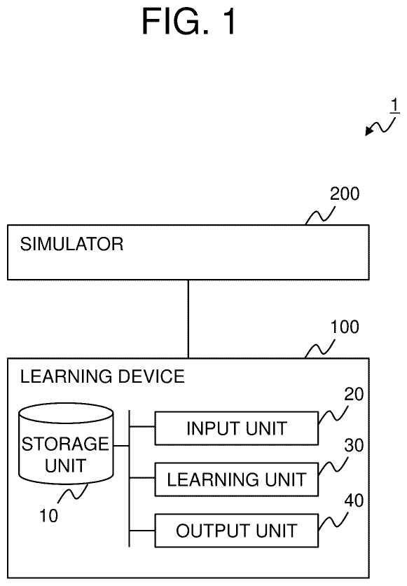

FIG. 1 is a block diagram illustrating a configuration example of one exemplary embodiment of a learning system according to the present invention. The learning system 1 in this exemplary embodiment includes a learning device 100 and a simulator 200. The learning device 100 and the simulator 200 are interconnected through a communication line.

The simulator 200 is a device that simulates the state of an agent. The agent of this exemplary embodiment is the equipment to be controlled and realizes the optimal action derived by a learned model. For example, in the factory line example described above, the agent corresponds to a robot that transports parts. The following example shows a robot that transports parts as a specific aspect of an agent. However, the aspect of the agent is not limited to a robot that transports parts. Other examples of agents include drones and self-driving cars that perform tasks autonomously according to a given route.

The simulator 200 simulates the state of an agent based on information indicating operating area of the agent (hereinafter referred to as “map information”), information of other related agents (hereinafter referred to as “related agent information”) and the high-level indicator. Examples of map information include route information within a facility (more specifically, obstacle information in a factory). Examples of relevant agent information include location and performance of other agents (more specifically, the assembly agent's location in the facility and production efficiency). The high-level indicator is a production indicator, such as production quantity and stock quantity, as described above.

Specifically, when the simulator 200 receives input for route plan for a mobile agent, it outputs various states, an agent action and reward information based on the map information, the relevant agent information, and the high-level indicator.

The various states include the state of the agent as well as the values of the high-level indicators (e.g., stock quantity, production quantity). The state of the agent may be represented, for example, as absolute location information, or may be represented relative to other agents or objects, as detected by sensors equipped by the agent. The agent's action represents changes in the agent's state over time. The reward information indicates the rewards obtained from the actions taken by the agent.

The aspect of the simulator 200 is optional and is prepared in advance. The simulator 200 may be realized, for example, by a computer processor operating according to a program. Specifically, the simulator 200 may be realized, for example, by a state transition model p (sₜ₊₁|sₜ, aₜ) that outputs results of transitioning the agent's time t and state sₜ to time t+1 and state sₜ₊₁ in response to a call. The simulator 200 may simulate the action of a single agent or may simulate the action of multiple agents collectively.

In the factory line example, the location and number of agents performing assembly work, initial inventory, and production efficiency may be given as hyperparameters μᵢ, and the number of parts that can be transported by a mobile agent may be given as a parameter. The simulator 200 may also obtain location information from obstacles in the factory and generate an arbitrary 2D map as map information.

The learning device 100 includes a storage unit 10, an input unit 20, a learning unit 30, and an output unit 40.

The storage unit 10 stores various information used by the learning device 100 for processing. For example, the storage unit 10 stores training data and a reward function used for learning by the learning unit 30 described below. The storage unit 10 is realized by, for example, a magnetic disk.

The input unit 20 accepts various information from the simulator 200 and other devices (not shown). In this exemplary embodiment, the input unit 20 may accept input of observed state, actions and reward information (e.g., immediate reward value) as training data from the simulator 200. The input unit 20 may read and input the training data from the storage unit 10 instead of from the simulator 200.

Furthermore, in this exemplary embodiment, the input unit 20 accepts input of a reward function that defines cumulative reward by a reward term based on a high-level indicator that represents the production indicator described above. The accepted reward function is used in the learning process by the learning unit 30 described below. The reward function may be stored in the storage unit 10 described above. In this case, the input unit 20 may read the reward function described above from the storage unit 10.

The following is a specific description of the reward function used in this exemplary embodiment. The input unit 20 of this exemplary embodiment accepts input of a reward function that defines the cumulative reward by multiple reward terms. More specifically, the input unit 20 accepts input of a reward function in which each reward term has a weight.

In this exemplary embodiment, in order to determine the agent's action that optimizes the physical indicator and logical indicator described above, the input unit 20 may accept input of a reward function that defines the cumulative reward by multiple reward terms that have a causal relationship. In order to be able to take optimal actions considering factors in a trade-off relationship, it is preferable that the input unit 20 accepts input of a reward function that defines cumulative rewards by multiple reward terms in a trade-off relationship. For example, the input unit 20 may accept the input of a reward function that defines the cumulative reward by a reward term representing stock quantity and a reward term representing production quantity.

For example, the cumulative reward can be expressed in Equation 1, described below.

$$\begin{matrix}[ Math . 1 ] & \\ R = {\sum }_{t = 0}^{H} r ( {s}_{t} , {a}_{t} ) & ( Equation 1 )\end{matrix}$$

Here, when defining a reward function that takes into account the production quantity and the stock quantity, it is preferable that the production quantity can be maximized and the stock quantity can be minimized. Therefore, the input unit 20 may accept input of the reward function exemplified in Equation 2 below, where the cumulative reward is defined by a reward term representing the stock quantity and a reward term representing the production quantity.

$$\begin{matrix}[ Math . 2 ] & \\ R = {\sum }_{t = 0}^{H} ( {r}_{product} ( t ) - {ar}_{stock} ( t ) ) & ( Equation 2 )\end{matrix}$$

In the example shown in Equation 2, r_{product} (t) is a reward term that takes on a larger value the greater the production quantity, and r_{stock} (t) is a reward term that takes on a larger value the greater the stock quantity. An example of product (t) is an expression that indicates the number of products produced per unit time. An example of r_{stock} (t) is the number of inventory units at time t. In addition, a in Equation 2 is a hyperparameter, which is defined according to the degree to be considered for each reward term. The hyperparameters may be defined for each reward term.

The reason for establishing such a hyperparameter is that the reward terms that should be emphasized differ depending on the product and industry. For example, for a product such as a personal computer, which is produced on an order basis, it is desirable to have a small inventory (stock). On the other hand, in the case of a product that is used for general purposes, such as a wi-fi router, it is desirable to maximize the number of products produced per unit time with some allowance for the number of stocks. Therefore, in the case of order-based products, the weight of the reward term with respect to the stock quantity will be set higher, while in the case of general-purpose products, the weight of the reward term with respect to the production quantity will be set higher.

The example shown in Equation 2 describes a case in which the reward function includes two reward terms, one representing the stock quantity and the other representing the production quantity. However, the number of reward terms included in the reward function is not limited to two, and the reward terms in a trade-off relationship are not limited to the reward term representing the stock quantity and the reward term representing the production quantity. Another example of the reward term in a trade-off relationship is the relationship between throughput and lead time. Other examples of reward terms are also explained in the specific examples below.

The learning unit 30 uses the training data and the input reward function to learn a value function for deriving optimal policy for the agent. For example, it is assumed that the value function used for the agent in the factory line described above is to be learned. In this case, the learning unit 30 may learn a value function that indicates the agent's (mobile's) policy using training data that includes a high-level indicator, location information of the agent (mobile), the agent's (mobile's) action, and reward information according to that action.

The method by which the learning unit 30 learns the value function is arbitrary. For example, the learning unit 30 may learn on a so-called value function basis, where the policies are given in terms of the value function, or it may learn on a so-called policy function basis, where the policies are derived directly.

For example, let q_{π}(s,a) be a value function based on the policy π. Note that s denotes a state and a denotes an action. In this case, the learning unit 30 may perform value function-based learning using, for example, the & Greedy method or the Boltzmann policy based on Equation 3, which is illustrated below.

$$\begin{matrix}[ Math . 3 ] & \\ π ( a \vert s ) = {arg max}_{a} q ( s , a ) & ( Equation 3 )\end{matrix}$$

$$where$$

$${q}_{π} ( s , a ) = {𝔼}_{π} [ R \vert {S}_{0} = s , {A}_{0} = a ]$$

Otherwise, if J(θ) is the expected return for a policy π_{θ} with θ as a parameter, the learning unit 30 may perform policy function-based learning using Equation 4, which is illustrated below.

$$\begin{matrix}[ Math . 4 ] & \\ J ( θ ) = 𝔼 [ R \vert {S}_{0} = s , {π}_{θ} ] , & ( Equation 4 )\end{matrix}$$

$$a ∼ {π}_{θ} ( a \vert s )$$

More specifically, the learning unit 30 may optimize the expected value by the Monte Carlo method. The learning unit 30 may also learn from the Boltzmann equation using the TD (Temporal Difference) method. However, the learning method described here is an example, and other learning method may be used.

The output unit 40 outputs the learned value function. The output value function is used, for example, to design a utility function.

The input unit 20, the learning unit 30, and the output unit 40 are realized by a processor (for example, CPU (Central Processing Unit)) of a computer that operates according to a program (learning program). For example, a program may be stored in a storage unit 10, and the processor may read the program and operate as the input unit 20, the learning unit 30, and the output unit 40 according to the program. In addition, the functions of the learning device 100 may be provided in the form of Saas (Software as a Service).

The input unit 20, the learning unit 30, and the output unit 40 may each be realized by dedicated hardware. Some or all of the components of each device may be realized by general-purpose or dedicated circuit, a processor, or combinations thereof. These may be configured by a single chip or by multiple chips connected through a bus. Some or all of the components of each device may be realized by a combination of the above-mentioned circuit, etc., and a program.

When some or all of the components of the learning device 100 are realized by multiple information processing devices, circuits, etc., the multiple information processing devices, circuits, etc. may be centrally located or distributed. For example, the information processing devices, circuits, etc. may be realized as a client-server system, a cloud computing system, etc., each of which is connected through a communication network.

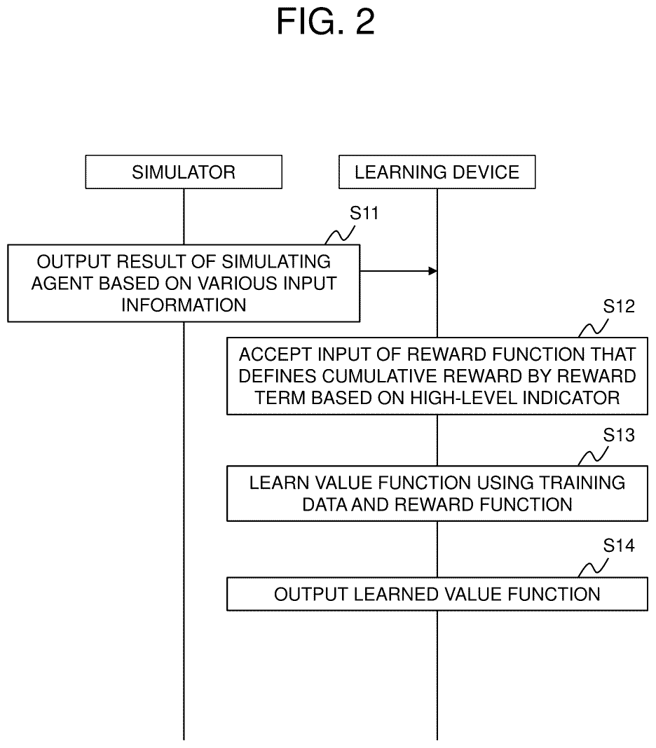

Next, the operation of the learning system 1 of this exemplary embodiment will be described. FIG. 2 is a flowchart illustrating an operation example of the learning system 1. The simulator 200 outputs results of simulating an agent (data including its high-level indicators, location information of the agent, the agent's action, and reward information for the action) based on various input information (map information, related agent information, high-level indicators, and agent route planning) (step S11).

The input unit 20 of the learning device 100 accepts input of a reward function that defines the cumulative reward by a reward term based on a high-level indicator (step S12). The learning unit 30 learns a value function for deriving optimal policy for an agent using training data and the reward function output from the simulator 200 (step S13). The output unit 40 then outputs the learned value function (step S14).

As described above, in this exemplary embodiment, the input unit 20 accepts input of a reward function that defines the cumulative reward by a reward term based on a high-level indicator, the learning unit 30 learns a value function using training data and the reward function, and the output unit 40 outputs the learned value function. Thus, it is possible to learn a model that derives optimal policy for the agent while increasing high-level indicator that represents the production indicators.

For example, general methods that focus on route planning are considered as a problem of minimizing the cost of the mobile agent and do not consider information indicating high-level indicators such as the stock quantity or number of inventories parts. In addition, general methods that focus on high-level indicators such as throughput and stock quantity have the optimization of logical indicators as their primary goal, and are not linked to the physical space. On the other hand, in this exemplary embodiment, the learning unit 30 learns a value function based on a reward function that considers both high-level and low-level indicators, thus enabling physical route planning and route negotiation while achieving the logical purpose.

Next, a specific configuration example using the learning system 1 of this exemplary embodiment will be described. In this specific example, it is assumed a situation where the route planning of a mobile agent (AGV) parts transportation on a factory line is performed in such a way as to minimize the number of internal stock quantity while maximizing the stock quantity. In addition, it is assumed a situation in which a mobile agent receives parts and passes the received parts to another agent (assembly agent) according to the planned route, repeating the process multiple times (i.e., multiple round trips). Therefore, the tasks of the mobile agent in this specific example are parts delivery and parts transportation.

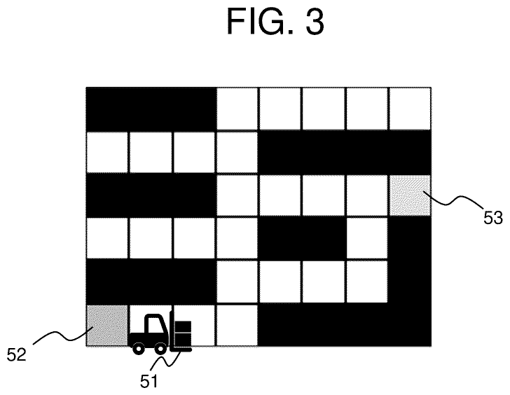

FIG. 3 is an explanatory diagram showing an example of a factory line. The factory line illustrated in FIG. 3 assumes that the agent 51 receives parts at the receiving point 52, transports the parts along a planned route to the delivery point 53, and passes the parts to another agent (assembly agent).

In this specific example, it is assumed that there are two assembly agents, each samples parts according to μᵢ˜N(μᵢ,σᵢ²) from inventory (stock) at time t when they can work, and each assembly agent is an agent that outputs the number of assembled parts nᵢ to the assembly parts storage area after t+μᵢ steps. Note that if there is no inventory (stock), the assembly agent stops its work.

Also, as the state s observed by the agent 51, let the position of the agent 51 at a certain time t (Grid world) s₁∈N× N′, the number of parts C={0, . . . , c} that the agent 51 is carrying, the first agent's inventory s₁∈{0, . . . , K′}, and the second agent's inventory s₂∈{0, . . . , K′}. In this specific example, the case in which state s is numerical data is described, but the method of indicating state s is not limited to numerical data. For example, if the location information of an agent is given as image information, a feature may be generated by applying the image information to a neural network such that the feature is extracted, and the feature may be used as the state s.

Then, it is assumed that the actions a∈A of the agent 51 are five: up, down, left, right, and stop. That is, A={0, . . . , 4}. In addition, it is assumed that the agent 51 can only move to the nearest grid in one step, and cannot move if there is an obstacle.

In this situation, the learning unit 30 learns a value function using the reward function shown in Equation 2 above, using the state s and action a observed at time t. In this specific example, the agent delivers goods (parts) during transportation. Therefore, the input unit 20 may accept input of a reward function that includes a reward term depending on whether or not the goods are successfully delivered during transportation. The learning unit 30 may then learn a value function using the accepted reward function.

For example, the reward term for package receipt is r_{get} and the reward term for package delivery is rₚₐₛₛ. For example, if the package is successfully received, r_{get}=1, if the package is successfully delivered, rₚₐₛₛ=1, and otherwise both r_{get} and rₚₐₛₛ may be set to 0. Then, when considering the reward term representing the stock quantity and the reward term representing the production quantity, the reward function can be expressed as in Equation 5 illustrated below.

$$\begin{matrix}[ Math . 5 ] & \\ {{r}^{′} ( {s}_{t} , {a}_{t} ) = {r}_{product} ( t ) - {ar}_{stock} ( t ) + {r}_{get} + {r}_{pass}}^{} & ( Equation 5 )\end{matrix}$$

By having the learning unit 30 use such a reward function to learn the value function, it is possible to have the agent 51 take appropriate actions that take into account both the stock quantity and the production quantity.

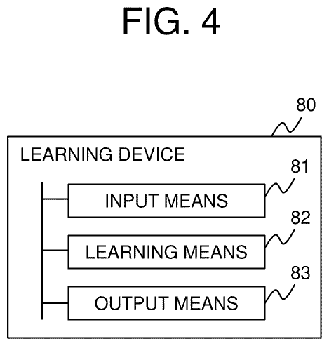

The following is an overview of the invention. FIG. 4 shows a block diagram illustrating the outline of a learning device according to the present invention. The learning device 80 (e.g., learning device 100) according to the present invention includes an input means 81 (e.g., input unit 20) which accepts input of a reward function that defines cumulative reward (e.g., Equations 1 and 2 above) by a reward term based on a high-level indicator representing a production indicator (e.g., stock quantity, production quantity, etc.), a learning means 82 (e.g., learning unit 30) which learns a value function for deriving optimal policy for an agent using training data and the reward function, and an output means 83 (e.g., output unit 40) which outputs the learned value function.

With such a configuration, it is possible to learn a model that derives optimal policy for an agent while increasing high-level indicator that represents production indicator.

The input means 81 may accept input of a reward function that defines the cumulative reward by multiple reward terms, and the learning means 82 may learn a value function using the reward function.

Specifically, the input means 81 may accept input of the reward function with weight set for each reward term.

The input means 81 may accept input of a reward function that defines cumulative reward by multiple reward terms each having a causal relationship, and the learning means 81 may learn a value function using the reward function.

The input means 81 may accepts input of a reward function that defines cumulative reward by multiple reward terms each having a trade-off relationship, and the learning means 82 may learn a value function using the reward function.

Specifically, the input means 81 may accept input of a reward function that defines cumulative reward by a reward term representing stock quantity and a reward term representing production quantity, and the learning means 82 may learn a value function using the reward function.

Alternatively, the input means 81 may accept input of a reward function that defines cumulative reward by a reward term representing a lead time and a reward term representing a throughput, and the learning means 82 may learn a value function using the reward function.

The learning means 82 may learn a value function that indicates a policy of an agent using training data that includes high-level indicator, location information of the agent, an action of the agent, and reward information according to the action.

The input means 81 may accept input of a reward function that includes a reward term depending on success or failure of delivery of goods during transportation, and the learning means 82 may learn a value function using the reward function.

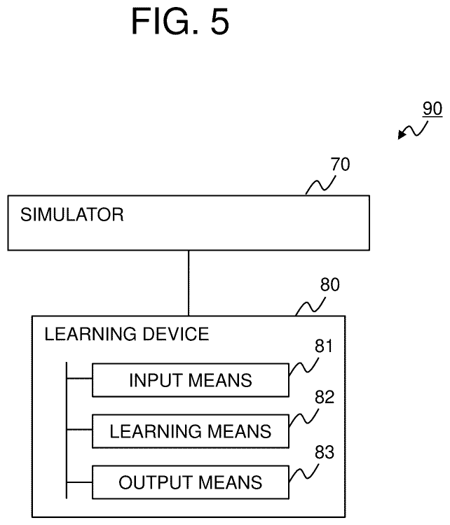

FIG. 5 is a block diagram illustrating the outline of a learning system according to the present invention. The learning system 90 (e.g., learning system 1) according to the present invention includes a simulator 70 (e.g., simulator 200) and a learning device 80 (e.g., learning device 100).

The simulator 70 outputs data including a high-level indicator, location information of an agent, an action of the agent, and reward information according to the action, from map information which is information indicating operating area of the agent, related agent information which is information of other related agents, the high-level indicator which represents a production indicator, and a route plan of the agent.

The configuration of the learning device 80 is the same as that illustrated in FIG. 4. Such a configuration also makes it possible to learn a model that derives optimal policy for an agent while increasing high-level indicator that represents production indicator.

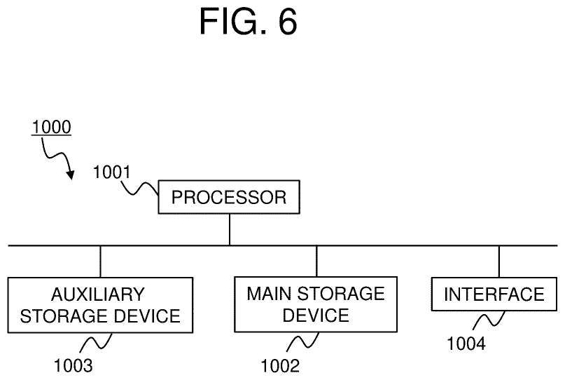

FIG. 6 is a schematic block diagram illustrating a configuration of a computer according to at least one exemplary embodiment. A computer 1000 includes a processor 1001, a main storage device 1002, an auxiliary storage device 1003, and an interface 1004.

The learning system described above is implemented in the computer 1000. Then, the operation of each processing unit described above is stored in the auxiliary storage device 1003 in the form of a program (learning program). The processor 1001 reads the program from the auxiliary storage device 1003, develops the program in the main storage device 1002, and executes the above processing according to the program.

Note that, in at least one exemplary embodiment, the auxiliary storage device 1003 is an example of a non-transitory tangible medium. Other examples of the non-transitory tangible medium include a magnetic disk, a magneto-optical disk, a compact disc read-only memory (CD-ROM), a digital versatile disk (DVD)-ROM, a semiconductor memory, and the like connected via the interface 1004. Furthermore, in a case where the program is distributed to the computer 1000 via a communication line, the computer 1000 that has received the program may develop the program in the main storage device 1002 and execute the above processing.

Furthermore, the program may be for implementing some of the functions described above. In addition, the program may be a program that implements the above-described functions in combination with another program already stored in the auxiliary storage device 1003, a so-called difference file (difference program).

Although some or all of the above exemplary embodiments may also be described as in the following Supplementary notes, but not limited to the following.

(Supplementary note 1) A learning device comprising:
an input means which accepts input of a reward function that defines cumulative reward by a reward term based on a high-level indicator representing a production indicator;
a learning means which learns a value function for deriving optimal policy for an agent using training data and the reward function; and
an output means which outputs the learned value function.

(Supplementary note 2) The learning device according to Supplementary note 1, wherein
the input means accepts input of a reward function that defines the cumulative reward by multiple reward terms, and
the learning means learns a value function using the reward function.

(Supplementary note 3) The learning device according to Supplementary note 2, wherein
the input means accepts input of the reward function with weight set for each reward term.

(Supplementary note 4) The learning device according to any one of Supplementary notes 1 to 3, wherein
the input means accepts input of a reward function that defines cumulative reward by multiple reward terms each having a causal relationship, and
the learning means learns a value function using the reward function.

(Supplementary note 5) The learning device according to any one of Supplementary notes 1 to 4, wherein
the input means accepts input of a reward function that defines cumulative reward by multiple reward terms each having a trade-off relationship, and
the learning means learns a value function using the reward function.

(Supplementary note 6) The learning device according to any one of Supplementary notes 1 to 5, wherein
the input means accepts input of a reward function that defines cumulative reward by a reward term representing stock quantity and a reward term representing production quantity, and
the learning means learns a value function using the reward function.

(Supplementary note 7) The learning device according to any one of Supplementary notes 1 to 5, wherein
the input means accepts input of a reward function that defines cumulative reward by a reward term representing a lead time and a reward term representing a throughput, and
the learning means learns a value function using the reward function.

(Supplementary note 8) The learning device according to any one of Supplementary notes 1 to 7, wherein
the learning means learns a value function that indicates a policy of an agent using training data that includes high-level indicator, location information of the agent, an action of the agent, and reward information according to the action.

(Supplementary note 9) The learning device according to any one of Supplementary notes 1 to 8, wherein
the input means accepts input of a reward function that includes a reward term depending on success or failure of delivery of goods during transportation, and
the learning means learns a value function using the reward function.

(Supplementary note 10) A learning system comprising:
a simulator which outputs data including a high-level indicator, location information of an agent, an action of the agent, and reward information according to the action, from map information which is information indicating operating area of the agent, related agent information which is information of other related agents, the high-level indicator which represents a production indicator, and a route plan of the agent; and
a learning device that uses data output from the simulator as training data for learning;
wherein the learning system includes:
an input means which accepts input of a reward function that defines cumulative reward by a reward term based on the high-level indicator;
a learning means which learns a value function for deriving optimal policy for the agent using the training data and the reward function; and
an output means which outputs the learned value function.

(Supplementary note 11) The learning system according to Supplementary note 10, wherein
the simulator outputs data including the high-level indicator, location information of agent transporting goods, an action of the agent, and reward information according to the action, from route information within a facility showing map information, location and performance of the agent to which the goods are to be transported showing related agent information, the high-level indicator, and route plan of the agent.

(Supplementary note 12) A learning method comprising:
accepting input of a reward function that defines cumulative reward by a reward term based on a high-level indicator representing a production indicator by a computer;
learning a value function for deriving optimal policy for an agent using training data and the reward function by the computer; and
outputting the learned value function by the computer.

(Supplementary note 13) The learning method according to Supplementary note 12, wherein
the computer accepts input of a reward function that defines the cumulative reward by multiple reward terms, and
the computer learns a value function using the reward function.

(Supplementary note 14) A program storage medium for storing a learning program for causing a computer to execute:
input process for accepting input of a reward function that defines cumulative reward by a reward term based on a high-level indicator representing a production indicator;
learning process for learning a value function for deriving optimal policy for an agent using training data and the reward function; and
output process for outputting the learned value function.

(Supplementary note 15) The program storage medium for storing the learning program according to Supplementary note 14, for causing the computer to further execute:
to accept input of a reward function that defines the cumulative reward by multiple reward terms in the input process; and
to learn a value function using the reward function in the learning process.

(Supplementary note 16) A learning program for causing computer to execute:
input process for accepting input of a reward function that defines cumulative reward by a reward term based on a high-level indicator representing a production indicator;
learning process for learning a value function for deriving optimal policy for an agent using training data and the reward function; and
output process for outputting the learned value function.

(Supplementary note 17) The learning program according to Supplementary note 14, for causing the computer to further execute:
to accept input of a reward function that defines the cumulative reward by multiple reward terms in the input process; and
to learn a value function using the reward function in the learning process.

### REFERENCE SIGNS LIST

1 Learning System
10 Storage unit
20 Input unit
30 Learning unit
40 Output unit
100 Learning device
200 Simulator

What is claimed is:

1. A learning device comprising:
a memory storing instructions; and
one or more processors configured to execute the instructions to:
accept input of a reward function that defines cumulative reward by a reward term based on a high-level indicator representing a production indicator;
learn a value function for deriving optimal policy for an agent using training data and the reward function; and
output the learned value function.

2. The learning device according to claim 1, wherein the processor is configured to execute the instructions to:
accept input of a reward function that defines the cumulative reward by multiple reward terms, terms; and
learn a value function using the reward function.

3. The learning device according to claim 2, wherein the processor is configured to execute the instructions to accept input of the reward function with weight set for each reward term.

4. The learning device according to claim 1, wherein the processor is configured to execute the instructions to:
accept input of a reward function that defines cumulative reward by multiple reward terms each having a causal relationship; and
learn a value function using the reward function.

5. The learning device according to claim 1, wherein the processor is configured to execute the instructions to:
accept input of a reward function that defines cumulative reward by multiple reward terms each having a trade-off relationship, relationship; and
learn a value function using the reward function.

6. The learning device according to claim 1, wherein the processor is configured to execute the instructions to:
accept input of a reward function that defines cumulative reward by a reward term representing stock quantity and a reward term representing production quantity; and
learn a value function using the reward function.

7. The learning device according to claim 1, wherein the processor is configured to execute the instructions to:
accept input of a reward function that defines cumulative reward by a reward term representing a lead time and a reward term representing a throughput; and
learn a value function using the reward function.

8. The learning device according to claim 1, wherein the processor is configured to execute the instructions to learn a value function that indicates a policy of an agent using training data that includes high-level indicator, location information of the agent, an action of the agent, and reward information according to the action.

9. The learning device according to claim 1, wherein the processor is configured to execute the instructions to:
accept input of a reward function that includes a reward term depending on success or failure of delivery of goods during transportation; and
learn a value function using the reward function.

10. A learning system comprising:
a simulator which outputs data including a high-level indicator, location information of an agent, an action of the agent, and reward information according to the action, from map information which is information indicating operating area of the agent, related agent information which is information of other related agents, the high-level indicator which represents a production indicator, and a route plan of the agent; and
a learning device that uses data output from the simulator as training data for learning;
wherein the learning system includes:
an input unit which accepts input of a reward function that defines cumulative reward by a reward term based on the high-level indicator;
a learning unit which learns a value function for deriving optimal policy for the agent using the training data and the reward function; and
an output unit which outputs the learned value function.

11. The learning system according to claim 10, wherein
the simulator outputs data including the high-level indicator, location information of agent transporting goods, an action of the agent, and reward information according to the action, from route information within a facility showing map information, location and performance of the agent to which the goods are to be transported showing related agent information, the high-level indicator, and route plan of the agent.

12. A learning method comprising:
accepting input of a reward function that defines cumulative reward by a reward term based on a high-level indicator representing a production indicator by a computer;
learning a value function for deriving optimal policy for an agent using training data and the reward function by the computer; and
outputting the learned value function by the computer.

13. The learning method according to claim 12, wherein
the computer accepts input of a reward function that defines the cumulative reward by multiple reward terms, and
the computer learns a value function using the reward function.

14. A non-transitory computer readable information recording medium storing a learning program, when executed by a processor, that performs a method for:
accepting input of a reward function that defines cumulative reward by a reward term based on a high-level indicator representing a production indicator;
learning a value function for deriving optimal policy for an agent using training data and the reward function; and
outputting the learned value function.

15. The non-transitory computer readable information recording medium according to claim 14, for causing the computer to further execute:
input of a reward function that defines the cumulative reward by multiple reward terms is accepted; and
a value function is learned using the reward function.
